(19) United States
(12) Patent Application Publication
(10) Pub. No.: US 2022/0355440 A1
(43) Pub. Date: Nov. 10, 2022

(54) HOT WATER GENERATION METHOD FOR CHEMICAL MECHANICAL POLISHING

(71) Applicant: Applied Materials, Inc., Santa Clara, CA (US)

(72) Inventors: Hari Soundararajan, Sunnyvale, CA (US); Chad Pollard, San Jose, CA (US); Alexander John Fisher, Santa Clara, CA (US); Shou-Sung Chang, Mountain View, CA (US); Haosheng Wu, San Jose, CA (US); Jianshe Tang, San Jose, CA (US)

(21) Appl. No.: 17/735,042

(22) Filed: May 2, 2022

Related U.S. Application Data
(60) Provisional application No. 63/183,849, filed on May 4, 2021.

(51) Int. Cl. B24B 53/017; B08B 3/10

(52) U.S. Cl. CPC B24B 53/017; B08B 3/106; B08B 2203/007

(57) ABSTRACT

A chemical mechanical polishing system includes a platen to support a polishing pad, a carrier head, a motor to generate relative motion between the platen and the carrier head, a steam generator including a vessel having a water inlet and one or more steam outlets and a heating element configured to apply heat to a portion of lower chamber to generate steam, a nozzle oriented to deliver steam from the steam generator onto the polishing pad, a tank to hold a cleaning fluid, a first valve in a first fluid line between the vessel and the nozzle to controllably connect and disconnect the vessel and the nozzle, a second valve in a second fluid line between the vessel and the tank to controllably connect and disconnect the vessel and the tank such that steam from the vessel heats fluid in the tank.

### CROSS-REFERENCE TO RELATED APPLICATIONS

This application claims the benefit of priority to U.S. application Ser. No. 63/183,849, filed on May 4, 2021, the contents of which are hereby incorporated by reference.

### TECHNICAL FIELD

The present disclosure relates to generation of steam for substrate processing tools, e.g., for chemical mechanical polishing (CMP).

### BACKGROUND

An integrated circuit is typically formed on a substrate by the sequential deposition of conductive, semiconductive, or insulative layers on a semiconductor wafer. A variety of fabrication processes require planarization of a layer on the substrate. For example, one fabrication step involves depositing a filler layer over a non-planar surface and polishing the filler layer until the top surface of a patterned layer is exposed. As another example, a layer can be deposited over a patterned conductive layer and planarized to enable subsequent photolithographic steps.

Chemical mechanical polishing (CMP) is one accepted method of planarization. This planarization method typically requires that the substrate be mounted on a carrier head. The exposed surface of the substrate is typically placed against a rotating polishing pad. The carrier head provides a controllable load on the substrate to push it against the polishing pad. A polishing slurry with abrasive particles is typically supplied to the surface of the polishing pad.

The polishing rate in the polishing process can be sensitive to temperature. Various techniques have been proposed to control the temperature of the polishing process.

### SUMMARY

In one aspect, a chemical mechanical polishing system includes a platen to support a polishing pad, a carrier head to hold a substrate in contact with the polishing pad, a motor to generate relative motion between the platen and the carrier head, a steam generator including a vessel having a water inlet and one or more steam outlets and a heating element configured to apply heat to a portion of lower chamber to generate steam, a nozzle oriented to deliver steam from the steam generator onto the polishing pad, a tank to hold a cleaning fluid, a first valve in a first fluid line between the vessel and the nozzle to controllably connect and disconnect the vessel and the nozzle, a second valve in a second fluid line between the vessel and the tank to controllably connect and disconnect the vessel and the tank such that steam from the vessel heats fluid in the tank, and a control system coupled to the first valve and the second valve, the control system configured to cause the first valve and the second valve to open and close.

Possible advantages may include, but are not limited to, one or more of the following.

Steam, i.e., gaseous H₂O generated by boiling, can be generated in sufficient quantity to permit steam heating of the polishing pad before polishing of each substrate, and the steam can be generated at a consistent pressure from wafer-to-wafer. Polishing pad temperature, and thus polishing process temperature, can be controlled and be more uniform on a wafer-to-wafer basis, reducing wafer-to-wafer non-uniformity (WIWNU). Generation of excess steam can be minimized, improving energy efficiency. The steam can be substantially pure gas, e.g., have little to no suspended liquid in the steam. Such steam, also known as dry steam, can provide a gaseous form of H₂O that has a higher energy transfer and lower liquid content than other steam alternatives such as flash steam.

Further, redundant steam, such as steam generated beyond the pressure setpoint determined by a pressure valve of a steam generator, can be used for other purposes, e.g., directed into a water tank to heat up the water, which can then be transferred to various components of the chemical mechanical polishing system. This can also reduce the amount of power required to generate the steam and thus improve power efficiency.

The details of one or more implementations are set forth in the accompanying drawings and the description below. Other aspects, features, and advantages will be apparent from the description and drawings, and from the claims.

### BRIEF DESCRIPTION OF THE DRAWINGS

FIG. 1 is a schematic top view of an example polishing station of the chemical mechanical polishing apparatus.

FIG. 2 is a schematic cross-sectional view of an example conditioning head steam treating assembly.

FIG. 3 is a schematic cross-sectional view of an example steam generator.

### DETAILED DESCRIPTION

Chemical mechanical polishing operates by a combination of mechanical abrasion and chemical reaction at the interface between the substrate, polishing liquid, and polishing pad. During the polishing process, a significant amount of heat is generated due to friction between the surface of the substrate and the polishing pad. In addition, some processes also include an in-situ pad conditioning step in which a conditioning disk, e.g., a disk coated with abrasive diamond particles, is pressed against the rotating polishing pad to condition and texture the polishing pad surface. The abrasion of the conditioning process can also generate heat. For example, in a typical one minute copper CMP process with a nominal downforce pressure of 2 psi and removal rate of 8000 Å/min, the surface temperature of a polyurethane polishing pad can rise by about 30° C.

On the other hand, if the polishing pad has been heated by previous polishing operations, when a new substrate is initially lowered into contact with the polishing pad, it is at a lower temperature, and thus can act as a heat sink. Similarly, slurry dispensed onto the polishing pad can act as a heat sink. Overall, these effects result in variation of the temperature of the polishing pad spatially and over time.

One technique that has been proposed to control the temperature of the chemical mechanical polishing process is to spray steam onto the polishing pad. Steam might be superior to hot water because less steam may be required to impart an equivalent amount of energy as hot water, e.g., due to the latent heat of the steam.

In a typical polishing process, steam is applied in a duty cycle (typically measured as a percentage of the total time from start of polishing of one wafer to start of polishing of a subsequent wafer) that can range from 1% to 100%. If the duty cycle is lower than 100%, the steam generation cycle can be split into two sections: a recuperation phase and a dispense phase.

In general, during the recuperation phase, the goal is to add sufficient thermal energy to get steam ready for the next dispense phase, as dictated by parameters (temperature, flow rate, pressure) that may be required for the process. However, excess steam can be generated in the recuperation phase. Excess steam can relieved, e.g., vented, to keep the required parameters, e.g. pressure. However, this consumes excess energy and is not energy efficient.

However, containing the redundant steam within the chemical mechanical polishing system permits for significant improvement in thermal efficiency of the system. The redundant steam can be used for other purposes, e.g., directed into a water tank to heat water to be directed to other components in the polishing system.

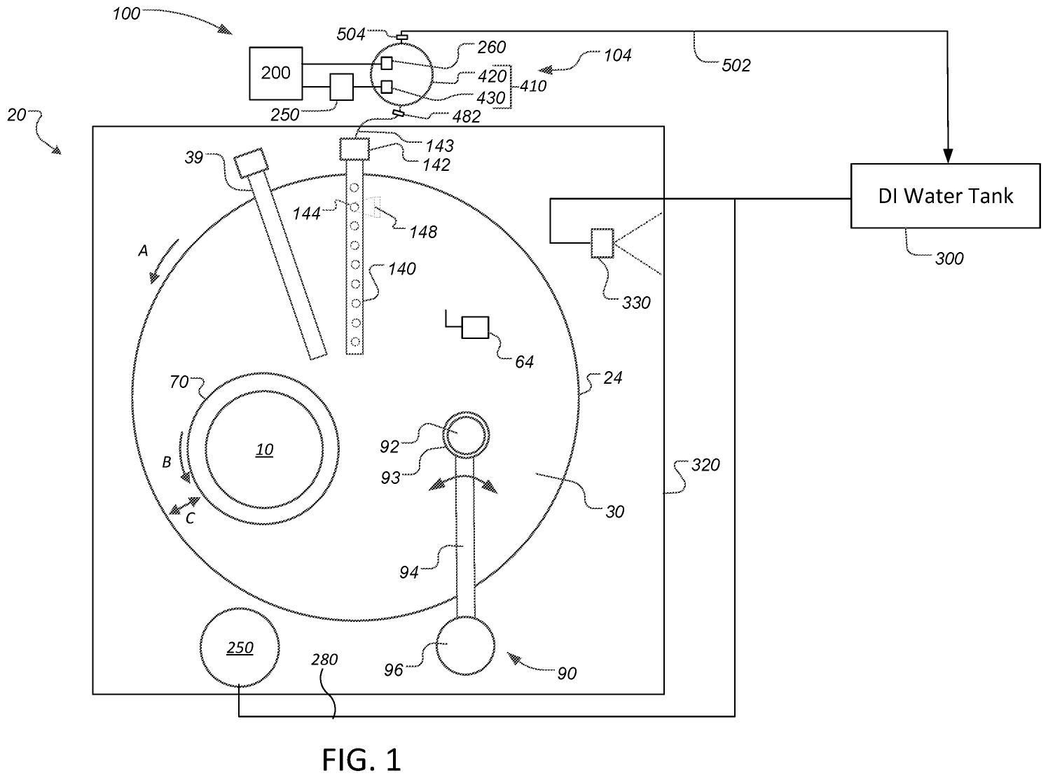

FIG. 1 illustrates an example of a polishing station 20 of a chemical mechanical polishing system. The polishing station 20 includes a rotatable disk-shaped platen 24 on which a polishing pad 30 is situated. The platen 24 is operable to rotate about an axis, as shown by arrow A in FIG. 1. The polishing pad 30 can be a two-layer polishing pad with an outer polishing layer and a softer backing layer.

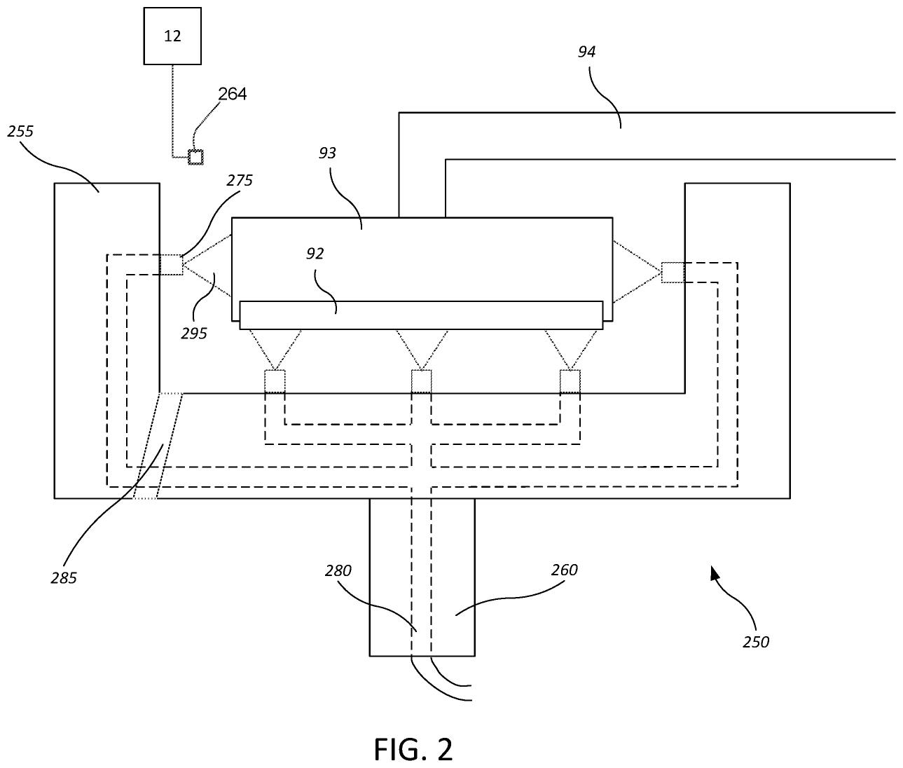

The polishing station 20 can include a supply port, e.g., at the end of a slurry supply arm 39, to dispense a polishing liquid, such as an abrasive slurry, onto the polishing pad 30. The polishing station 20 can also include a pad conditioner ststem 90 with a conditioner disk 92 held by a conditioner head 93 to maintain the surface roughness of the polishing pad 30. The conditioner head 93 can be positioned at the end of an arm 94 supported by a base 96. The conditioner head 93 can be movable, e.g., by pivoting the arm 94, and positionable in a conditioner head cleaner assembly 250. An example conditioning head steam treating assembly will be desccrtibed in more detail below with reference to FIG. 2.

A carrier head 70 is operable to hold a substrate 10 against the polishing pad 30. The carrier head 70can rotate as shown by the arrow B in FIG. 1. The carrier head 70 can also be translated laterally, as shown by arrow C in FIG. 1, across the top surface of the polishing pad 30. Optionally, the carrier head 70 can oscillate laterally.

In some implementations, the polishing station 20 includes a temperature sensor 64 to monitor a temperature in the polishing station or a component of/in the polishing station, e.g., the temperature of the polishing pad 30 and/or slurry on the polishing pad. For example, the temperature sensor 64 could be an infrared (IR) sensor, e.g., an IR camera, positioned above the polishing pad 30 and configured to measure the temperature of the polishing pad 30 and/or slurry on the polishing pad. In particular, the temperature sensor 64 can be configured to measure the temperature at multiple points along the radius of the polishing pad 30 in order to generate a radial temperature profile. For example, the IR camera can have a field of view that spans the radius of the polishing pad 30.

In some implementations, the temperature sensor is a contact sensor rather than a non-contact sensor. For example, the temperature sensor 64 can be thermocouple or IR thermometer positioned on or in the platen 24. In addition, the temperature sensor 64 can be in direct contact with the polishing pad.

In some implementations, multiple temperature sensors could be spaced at different radial positions across the polishing pad 30 in order to provide the temperature at multiple points along the radius of the polishing pad 30. This technique could be use in the alternative or in addition to an IR camera.

Although illustrated in FIG. 1 as positioned to monitor the temperature of the polishing pad 30 and/or slurry on the pad 30, the temperature sensor 64 could be positioned inside the carrier head 70 to measure the temperature of the substrate 10. The temperature sensor 64 can be in direct contact (i.e., a contacting sensor) with the semiconductor wafer of the substrate 10. In some implementations, multiple temperature sensors are included in the polishing station 20, e.g., to measure temperatures of different components of/in the polishing station 20.

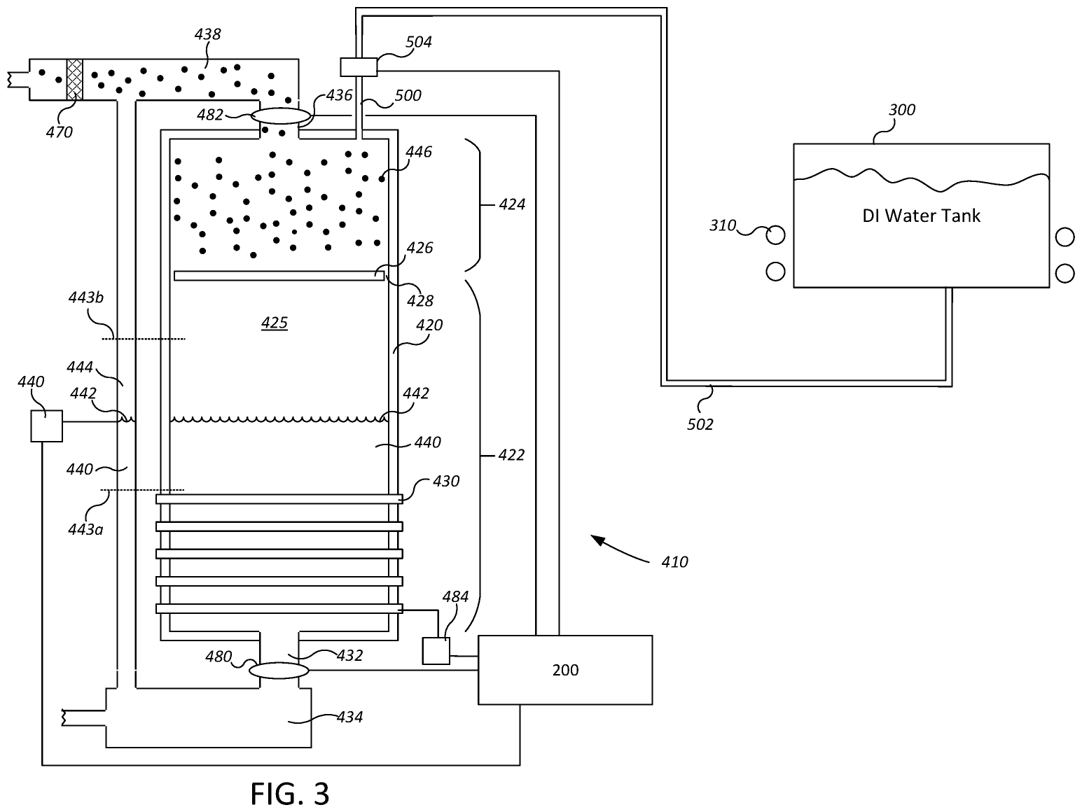

The polishing station 20 also includes a temperature control system 100 to control the temperature of the polishing pad 30 and/or slurry on the polishing pad 30. The temperature control system 100 includes a heating system 104 that operates by delivering steam a temperature-controlled medium onto the polishing surfaceof the polishing pad 30 (or onto a polishing liquid that is already present on the polishing pad). In particular, the medium includes steam, e.g., from a steam generator 410 (see FIG. 3). The steam can be mixed with another gas, e.g., air, or a liquid, e.g., heated water, or the medium can be substantially pure steam. In some implementations, the additives or chemicals are be added to the steam.

The medium can be delivered by flowing through apertures, e.g., holes or slots, e.g., provided by one or more nozzles, on a heating delivery arm. The apertures can be provided by a manifold that is connected to a source of the heating medium.

An example heating system 104 includes an arm 140 that extends over the platen 24 and polishing pad 30 from an edge of the polishing pad to or at least near (e.g., within 5% of the total radius of the polishing pad) the center of polishing pad 30. The arm 140 can be supported by a base 142, and the base 142 can be supported on the same frame as the platen 24. The base 142 can include one or more actuators, e.g., a linear actuator to raise or lower the arm 140, and/or a rotational actuator to swing the arm 140 laterally over the platen 24. The arm 140 is positioned to avoid colliding with other hardware components such as the polishing head 70, pad conditioning disk 92 and arm 94, and the slurry dispensing arm 39.

In some implementations, multiple openings 144 are formed in the bottom surface of the arm 140. Each opening 144 can be configured to direct a gas or vapor, e.g., steam, onto the polishing pad 30. The arm 140 can be supported by a base 142 so that the openings 144 are separated from the polishing pad 30 by a gap. The gap can be 0.5 to 5 mm. In particular, the gap can be selected such that the heat of the heating fluid does not significantly dissipate before the fluid reaches the polishing pad. For example, the gap can be selected such that steam emitted from the openings does not condense before reaching the polishing pad.

The heating system 104 can include a source of steam, e.g., a steam generator 410. The steam generator 410 can be connected to the openings 144 in the arm 140 by a fluid delivery line 143, which can be provided by piping, flexible tubing, passages through solid body that provides the arm 140, or a combination thereof

The steam generator includes 410 a vessel 420 to hold water, and a heater 430 to deliver heat to water in the vessel 420. Power can be delivered to the heater 430 from a power supply 250. A sensor 260 can be located in the vessel 420 or in the fluid delivery line 146 to measure a physical parameter, e.g., temperature or pressure, of the steam.

In some implementations, a process parameter, e.g., flow rate, pressure, temperature, and/or mixing ratio of liquid to gas, can be independently controlled for each nozzle. For example, the fluid for each opening 144 can flow through an independently controllable heater to independently control the temperature of the heating fluid, e.g., the temperature of the steam.

The various openings 144 can direct steam 148 onto different radial zones on the polishing pad 30. Adjacent radial zones can overlap. Optionally, one or more of the openings 144 can be oriented so that a central axis of the spray from that opening is at an oblique angle relative to the polishing surface of the polishing pad 30. Steam can be directed from one or more of the openings 144 to have a horizontal component in a direction opposite to the direction of motion of the polishing pad 30 in the region of impingement as caused by rotation of the platen 24.

Although FIG. 1 illustrates the openings 144 as spaced at even intervals, this is not required. Openings 144 could be distributed non-uniformly either radially, or angularly, or both. For example, openings 144 could be clustered more densely toward the center of the polishing pad 30. As another example, openings 144 could be clustered more densely at a radius corresponding to a radius at which the polishing liquid is delivered to the polishing pad 30 by the slurry delivery arm 39. In addition, although FIG. 1 illustrates nine openings, there could be a larger or smaller number of openings.

The temperature of the steam 148 can be 90 to 200° C. when the steam is generated (e.g., in the steam generator 410 in FIG. 3). The temperature of the steam can be between 90 to 150° C. when the steam is dispensed by the openings 144, e.g., due to heat loss in transit. In some implementations, steam is delivered by the openings 144 at a temperature of 70-100° C., e.g., 80-90° C. In some implementations, the steam delivered by the openings is superheated, i.e., is at a temperature above the boiling point.

The flow rate of the steam can be 1-1000 cc/minute when the steam is delivered by the openings 144, depending on heater power and pressure. In some implementations, the steam is mixed with other gases, e.g., is mixed with normal atmosphere or with N2. Alternatively, the fluid delivered by the openings 144 is substantially purely water. In some implementations, the steam 148 delivered by the openings 144 is mixed with liquid water, e.g., aerosolized water. For example, liquid water and steam can be combined at a relative flow ratio (e.g., with flow rates in sccm) 1:1 to 1:10. However, if the amount of liquid water is low, e.g., less than 5 wt %, e.g., less than 3 wt %, e.g., less than 1 wt %, then the steam will have superior heat transfer qualities. Thus, in some implementations the steam is dry steam, i.e., is substantially free of water droplets.

The polishing station 20 can also include a cooling system, e.g., an arm with apertures to dispense a coolant fluid onto the polishing pad, a high pressure rinsing system, e.g., an arm with nozzles to spray a rinsing liquid onto the polishing pad, and a wiper blade or body to evenly distribute the polishing liquid across the polishing pad 30.

In some implementations, at least some components of the polishing station 20 are enclosed by a housing 320. For example, the platen 30, carrier head 70, conditioner system 90, and delivery arms 39, 140, can be positioned within the housing 320.

The polishing system 20 also includes a control system 200 to control operation of various components, e.g., the temperature control system 100, as well as rotation of the carrier head, rotation of the platen, pressure applied by chambers in the carrier head, etc.

The control system 200 can be configured to receive the pad temperature measurements from the temperature sensor 64. The control system can control the amount of heat delivered to the polishing pad 30, e.g., by controlling a valve 482 in the fluid delivery line 143 so as to control the flow rate of steam from the steam generator 410 to the polishing pad 30.

The control system 200, and the functional operations thereof, can be implemented in digital electronic circuitry, in tangibly-embodied computer software or firmware, in computer hardware, or in combinations of one or more of them. The computer software can be implemented as one or more computer programs, i.e., one or more modules of computer program instructions encoded on a tangible non transitory storage medium for execution by, or to control the operation of, a processor of a data processing apparatus. The electronic circuitry and data processing apparatus can include a general purpose programmable, a programmable digital processor, and/or multiple digital processors or computers, as well as be special purpose logic circuitry, e.g., an FPGA (field programmable gate array) or an ASIC (application specific integrated circuit).

For the control system to be “configured to” perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

FIG. 2, shows an example conditioning head cleaning assembly 250 that includes a housing 255. The housing 255 can form a “cup” to receive a conditioner disk 92 and conditioner head 93. Cleaning fluid, e.g., heated water from a DI water tank 300 (see FIG. 1), is circulated through a supply line 280 in the housing 255 to one or more nozzles 275. The nozzles 275 can spray the cleaning fluid 295 to remove polishing by-product, e.g., debris or slurry particles, left on the conditioner disk 92 and/or conditioner head 93 after each conditioning operation. The nozzles 275 can be located in the housing 255, e.g., on a floor, side wall, or ceiling of an interior of the housing 255. One or more nozzles can be positioned to clean the bottom surface of the pad conditioner disk, and/or the bottom surface, side-walls and/or and top surface of the conditioner head 93. A drain 285 can permit excess water, cleaning solution, and cleaning by-product to pass through to prevent accumulation in the housing 255.

The conditioner head 93 and conditioner disk 92 can be lowered at least partially into the housing 255 to be cleaned. When the conditioner disk 92 is to be returned to operation, the conditioner head 93 and conditioning disk 92 are lifted out of the housing 255 and positioned on the polishing pad 30 to condition the polishing pad 30. When the conditioning operation is completed, the conditioner head 93 and conditioning disk 92 are lifted off the polishing pad and swung back to the housing cup 255 for the polishing by-product on the conditioner head 93 and conditioner disk 92 to be removed. In some implementations, the housing 255 is vertical actuatable, e.g., is mounted to a vertical drive shaft 260.

Referring to FIG. 3, steam for the processes described in this description, or for other uses in a chemical mechanical polishing system, can be generated using the steam generator 410. An exemplary steam generator 410 can include a canister 420 that encloses an interior volume 425. The walls of the canister 420 can be made of a thermally insulating material with a very low level of mineral contaminants, e.g., quartz. Alternatively, the walls of the canister could be formed of another material, e.g., and an interior surface of the canister could be coated with polytetrafluoroethylene (PTFE) or another plastic. In some implementations, the canister 420 can be 10-20 inches long, and 1-5 inches wide.

In some embodiments, the interior volume 425 of the canister 420 is divided into a lower chamber 422 and an upper chamber 424 by a barrier 426. The barrier 426 can be made of the same material as the canister walls, e.g., quartz, stainless steel, aluminum, or a ceramic such as alumina. Quartz may be superior in terms of lower risk of contamination. The barrier 426 can substantially prevent the liquid water 440 from entering the upper chamber 424 by blocking water droplets splattered by the boiling water. This permits the dry steam to accumulate in the upper chamber 424.

The barrier 426 includes one or more apertures 428. The apertures 428 permit the steam to pass from the lower chamber 422 into the upper chamber 424. The apertures 428—and particularly the apertures 428 near the edge of the barrier 426—can allow for condensate on the walls of the upper chamber 424 to drip down into the lower chamber 422 to reduce the liquid content in the upper chamber 426 and permit the liquid to be reheated with the water 440.

The apertures 428 can be located at the edges, e.g., only at the edges, of the barrier 426 where the barrier 426 meets the inner walls of the canister 420. The apertures 428 can be located near the edges of the barrier 426, e.g., between the edge of the barrier 426 and the center of the barrier 426. This configuration can be advantageous in that the barrier 426 lacks apertures in the center and thus has reduced risk of liquid water droplets entering the upper chamber, while still permitting condensate on the side walls of the upper chamber 424 to flow out of the upper chamber.

However, in some implementations, apertures are also positioned away from the edges, e.g., across the width of the barrier 426, e.g., uniformly spaced across the area of the barrier 425.

A water inlet 432 can connect a water reservoir 434 to the lower chamber 422 of the canister 420. The water inlet 432 can be located at or near the bottom of the canister 420 to provide the lower chamber 422 with water 440.

One or more heating elements 430 can surround a portion of the lower chamber 422 of the canister 420. The heating element 430, for example, can be a heating coil, e.g., a resistive heater, wrapped around the outside of the canister 420. The heating element can also be provided by a thin film coating on the material of the side walls of the canister; if current is applied then this thin film coating can serve as a heating element.

The heating element 430 can also be located within the lower chamber 422 of the canister 420. For example, the heating element can be coated with a material that will prevent contaminants, e.g., metal contaminants, from the heating element from migrating into the steam.

The heating element 430 can apply heat to a bottom portion of the canister 420 up to a minimum water level 443a. That is, the heating element 430 can cover portions of the canister 420 that is below the minimum water level 443a to prevent overheating, and to reduce unnecessary energy expenditures.

A first steam outlet 436 can connect the upper chamber 424 to a steam delivery passage 438. The steam delivery passage 438 can be located at the top or near the top of the canister 420, e.g., in the ceiling of the canister 420, to allow steam to pass from the canister 420 into the steam delivery passage 438, and to the various components of the CMP apparatus. The first steam delivery passage 438 can be used to funnel steam towards various areas of the chemical mechanical polishing apparatus, e.g., for steam cleaning and preheating of the polishing pad 30.

In some implementations, a filter 470 is coupled to the steam outlet 438 configured to reduce contaminants in the steam 446. The filter 470 can be an ion-exchange filter.

Water 440 can flow from the water reservoir 434 through the water inlet 432 and into the lower chamber 422. The water 440 can fill the canister 420 at least up to a water level 442 that is above the heating element 430 and below the barrier 426. As the water 440 is heated, gas media 446 is generated and rises through the apertures 428 of the barrier 426. The apertures 428 permit steam to rise and simultaneously permit condensation to fall through, resulting in a gas media 446 in which the water is steam that is substantially free of liquid (e.g., does not have liquid water droplets suspended in the steam).

In some implementations, the water level is determined using a water level sensor 460 measuring the water level 442 in a bypass tube 444. The bypass tube connects the water reservoir 434 to the steam delivery passage 438 in parallel with the canister 420. The water level sensor 460 can indicate where the water level 442 is within the bypass tube 444, and accordingly, the canister 420. For example, the water level sensor 444 and the canister 420 are equally pressured (e.g., both receive water from the same water reservoir 434 and both have the same pressure at the top, e.g., both connect to the steam delivery passage 438), so the water level 442 is the same between the water level sensor and the canister 420. In some embodiments, the water level 442 in the water level sensor 444 can otherwise indicate the water level 442 in the canister 420, e.g., the water level 442 in the water level sensor 444 is scaled to indicate the water level 442 in the canister 420.

In operation, the water level 442 in the canister 420 is above a minimum water level 443a and below a maximum water level 443b. The minimum water level 443a is at least above the heating element 430, and the maximum water level 443b is sufficiently below the steam outlet 436 and the barrier 426 such that enough space is provided to allow gas media 446, e.g., steam, to accumulate near the top of the canister 420 and still be substantially free of liquid water.

In some implementations, the control system 200 is coupled to a valve 480 that controls fluid flow through the water inlet 432, a valve 482 that controls fluid flow through the steam outlet 436, and/or the water level sensor 460. Using the water level sensor 460, the control system 200 is configured to regulate the flow of water 440 going into the canister 420 and regulate the flow of gas 446 leaving the canister 420 to maintain a water level 442 that is above the minimum water level 443a (and above the heating element 430), and below the maximum water level 443b (and below the barrier 426, if there is a barrier 426). The control system 200 can also be coupled to the power supply 250 for the heating element 430 in order to control the amount of heat delivered to the water 440 in the canister 420.

During operation of the steam generator 410, excess steam can be generated in the canister 420. A second steam outlet 500 can connect the upper chamber 424 to a second steam delivery passage 502. The second steam delivery outlet 500 can be located at the top or near the top of the canister 420, e.g., in the ceiling of the canister 420, to allow steam to pass from the canister 420 into the second steam delivery passage 502. The control system 200 is coupled to a valve 504 that controls fluid flow through the second outlet 500 into the second steam delivery passage 502. Although FIG. 3 illustrates separate openings, there could be a single opening that connects to both passages 438, 500, e.g., through the valves 482, 504.

The second steam delivery passage 502 can be used to funnel steam to heat the tank 300. For example, the steam can be directed to bubble through the water in the tank. For example, second steam delivery passage 502 can be coupled to the floor of the tank 300. Alternatively, the steam can flow through a heat exchanger 310, e.g., heating tubes that surround the tank 300.

The control system 120 can be configured to cause only one of the two valves 482, 504 to be open at a time. In particular, during the recuperation phase, the control system 120 can be configured to cause both valves 482, 504 to be closed until a desired pressure is reached. The control system 120 can then cause second valve 504 to open (while the first valve 482 remains closed) to bleed excess steam pressure, which can then be used to heat the water in the tank 300. On the other hand, during the dispense phase, the control system 120 can cause the first valve 482 to open (while the second valve 504 is closed) to direct the steam onto the polishing pad 30.

Returning to FIG. 1, heated fluid, e.g., heated water, from the tank 300 can be used for various purposes. For example, the supply line 280 can be coupled to the tank 300 so that the heated fluid can be directed to the conditioner head cleaner assembly 250. As another example, heated fluid from the tank 300 can be sprayed from a nozzle 330 on the inside surface of the housing 320. As another example, heated fluid from the tank 300 can be sprayed from a nozzle on one or more other components, e.g., the carrier head.

As used in the instant specification, the term substrate can include, for example, a product substrate (e.g., which includes multiple memory or processor dies), a test substrate, a bare substrate, and a gating substrate. The substrate can be at various stages of integrated circuit fabrication, e.g., the substrate can be a bare wafer, or it can include one or more deposited and/or patterned layers. The term substrate can include circular disks and rectangular sheets.

Terms of relative positioning are used to denote positioning of components of the system relative to each other, not necessarily with respect to gravity; it should be understood that the polishing surface and substrate can be held in a vertical orientation or some other orientations.

A number of implementations have been described. Nevertheless, it will be understood that various modifications may be made. Accordingly, other implementations are within the scope of the claims.

1. A chemical mechanical polishing system, comprising:
a platen to support a polishing pad;
a carrier head to hold a substrate in contact with the polishing pad;
a motor to generate relative motion between the platen and the carrier head;
a steam generator including a vessel having a water inlet and one or more steam outlets, and a heating element configured to apply heat to a portion of lower chamber to generate steam;
a nozzle oriented to deliver steam from the steam generator onto the polishing pad;
a tank to hold a cleaning fluid;
a first valve in a first fluid line between the vessel and the nozzle to controllably connect and disconnect the vessel and the nozzle;
a second valve in a second fluid line between the vessel and the tank to controllably connect and disconnect the vessel and the tank such that steam from the vessel heats fluid in the tank; and
a control system coupled to the first valve and the second valve, the control system configured to cause the first valve and the second valve to open and close.

2. The system of claim 1, further comprising a conditioner head cleaning station to clean a conditioner head, and wherein the tank is coupled to the conditioner head cleaning station to supply cleaning fluid onto the conditioner head.

3. The system of claim 1, further comprising a carrier head rinsing station to rinse the carrier head, and wherein the tank is coupled to the carrier head rinsing station to supply cleaning fluid onto the carrier head.

4. The system of claim 1, further comprising a pad rinsing arm having one or more apertures, and wherein the tank is coupled to the pad rinsing arm to supply the cleaning fluid through the one or more apertures onto the polishing pad.

5. The system of claim 1, further comprising a housing surrounding the platen, and wherein the tank is coupled to a nozzle configured to deliver cleaning fluid to an interior surface of the housing.

6. The system of claim 1, wherein the second fluid line is coupled to the tank to inject the steam into fluid in the tank.

7. The system of claim 6, wherein the second fluid line is coupled to a floor of the tank.

8. The system of claim 1, wherein the second fluid line is coupled to a heat exchanger outside of the tank.

9. The system of claim 1, wherein the control system is configured to cause only one of the first valve and second valve to be open at a time.

10. The system of claim 1, wherein the control system is configured to cause both the first valve and second valve to be closed during a first portion of a recuperation phase.

11. The system of claim 10, wherein the control system is configured to cause the second valve to be open during a second portion of the recuperation phase.

12. The system of claim 11, wherein the control system is configured to open the second valve and start the second portion of the recuperation phase when a desired steam pressure is reached inside the vessel to bleed excess pressure into the second fluid line.

13. The system of claim 11, wherein the control system is configured to cause the second valve to be closed and the first valve to be open during a dispensing phase after the second portion of the recuperation phase.

14. A method of operating a chemical mechanical polishing system, comprising:
heating water in a vessel to generate steam during a first portion of a recuperation phase;
maintaining a first valve closed and opening a second valve to direct steam from the vessel to a tank to heat cleaning fluid in the tank during a second portion of the recuperation phase;
opening the first valve and closing the second valve to direct to direct steam from the vessel to a polishing pad of the chemical mechanical polishing system during a dispense phase; and
directing heated cleaning fluid from the vessel to another component of the polishing system.

15. The method of claim 14, comprising maintaining the first valve and the second valve closed until a pressure in the vessel reaches a threshold pressure.

16. The method of claim 15, comprising opening the second valve when pressure in the vessel reaches the threshold pressure to bleed excess pressure from the vessel.

17. The method of claim 14, wherein the another component comprises an inner surface of a housing surrounding a platen of the polishing system, a conditioner head cleaning station, a carrier head transfer station, or a pad rinsing system.

18. The method of claim 14, comprising injecting the steam into the cleaning fluid.

19. The method of claim 14, comprising circulating steam through a heat exchanger thermally coupled to the tank.
